(19) United States
(12) Patent Application Publication
(10) Pub. No.: US 2026/0063035 A1
(43) Pub. Date: Mar. 5, 2026

(54) LUNAR REGOLITH REDUCTION REACTOR SYSTEM AND METHOD OF PROCESSING LUNAR REGOLITH

(71) Applicant: Noah Plaza, Gibsonia, PA (US)

(72) Inventor: Noah Plaza, Gibsonia, PA (US)

(21) Appl. No.: 18/816,037

(22) Filed: Aug. 27, 2024

(51) Int. Cl. E21C 51/00; B01D 53/00; C25B 1/04

(52) U.S. Cl. CPC E21C 51/00; B01D 53/002; C25B 1/04

(57) ABSTRACT

A lunar regolith reduction reactor system includes a housing, a crucible, and a pair of electrodes. The housing includes a base structure and a cover structure detachably connected to the base structure, a gas input port to permit input of hydrogen gas into the housing, and a gas output port to permit outgassing of water vapor and gases. The crucible is designed to hold an amount of lunar regolith in the housing. The electrodes are disposed apart from one another and adjacent the crucible, wherein the electrodes are connectable to a power source to generate an electric arc to heat lunar regolith in the crucible and initiate a reduction reaction to separate oxygen gas and reduce separated material into a molten state.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to lunar and aerospace exploration technologies and more particularly pertains to a new lunar regolith reduction reactor system for processing lunar regolith into useful material. In the aerospace field, exploration to other worlds, such as planets and moons, beyond the Earth are of great interest, especially to the Moon since it has already been traveled to by humans. One key component of space exploration is the establishment of colonies on the planets or moons to allow for a base of operations. Unfortunately, establishment of a colony is exceptionally difficult because such colonies would need considerable materials and equipment, and currently space vehicles are quite limited in their payload capacity. For example, something as inexpensive as water is very expensive to transport through space. Therefore, efforts have been made to develop technology that would be capable of using the natural resources of the destination world. An example of one such resource is lunar regolith, also known as “moon dust,” located all over the surface of the Moon. Lunar regolith is comprised of a variety of minerals and oxidized metals, such as, for example, iron oxide, silicon dioxide, and titanium dioxide. The present invention proposes a device and method to process the lunar regolith by separating out oxygen through a reduction reaction to yield useful oxygen gas for both breathing and use in creating water, as well as useful metallic materials for use in making building and construction objects and machine parts. The lunar regolith reduction reactor system is also possibly useful for processing regolith on other worlds, such as Mars.

### (2) Description of Related Art Including Information Disclosed Under 37 CFR 1.97 and 1.98

The prior art relates to lunar and aerospace exploration technologies. The prior art, as best understood, discloses proposed devices and methods of processing lunar regolith. However, these systems use very large and complex furnaces and reactors that would be extremely difficult to build on the Moon. In addition, some of these methods require filtration of the lunar regolith to separate out different particles, which filtration process also requires extensive equipment and is generally inefficient in filtering the very fine lunar regolith. In contrast, the present invention discloses a lunar regolith reduction reactor system that includes a housing, a crucible, and a pair of electrodes, wherein the system is relatively compact and the electrodes are designed to generate an electric arc, the heat of which initiates a reduction reaction in the unfiltered lunar regolith in the crucible and surrounding additive hydrogen, which results in bringing the reduced material to a molten state.

### BRIEF SUMMARY OF THE INVENTION

An embodiment of the disclosure meets the needs presented above in a lunar regolith reduction reactor system generally comprising a housing, a crucible, and a pair of electrodes. The housing includes a base structure and a cover structure detachably connected to the base structure, a gas input port to permit input of hydrogen gas into the housing, and a gas output port to permit outgassing of water vapor and gases. The crucible is designed to hold an amount of lunar regolith in the housing. The electrodes are disposed apart from one another and adjacent the crucible, wherein the electrodes are connectable to a power source to generate an electric arc to heat lunar regolith in the crucible and initiate a reduction reaction to separate oxygen gas and reduce separated material into a molten state.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a perspective view of a lunar regolith reduction reactor system according to an embodiment of the disclosure.

FIG. 2 is an exploded view of an embodiment of the disclosure.

FIG. 3 is an exploded view of an embodiment of the disclosure.

FIG. 4 is a top view of an embodiment of the disclosure.

FIG. 5 is a cross-sectional view of an embodiment of the disclosure.

FIG. 6 is a cross-sectional view of an embodiment of the disclosure.

FIG. 7 is a close-up view of a component of an embodiment of the disclosure.

FIG. 8 is a close-up view of a component of an embodiment of the disclosure.

FIG. 9 is a side view of different uses of an embodiment of the disclosure.

FIG. 10 is a perspective view of an embodiment of the disclosure in use.

### DETAILED DESCRIPTION OF THE INVENTION

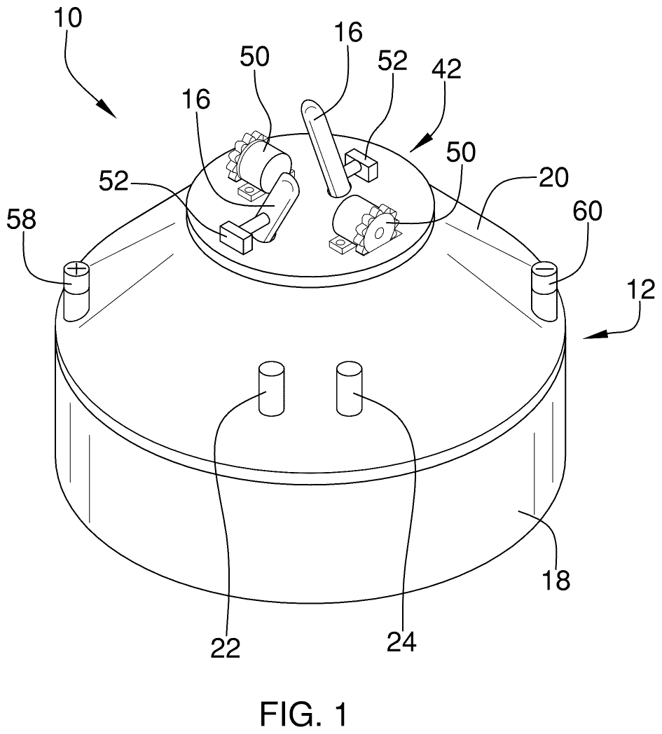

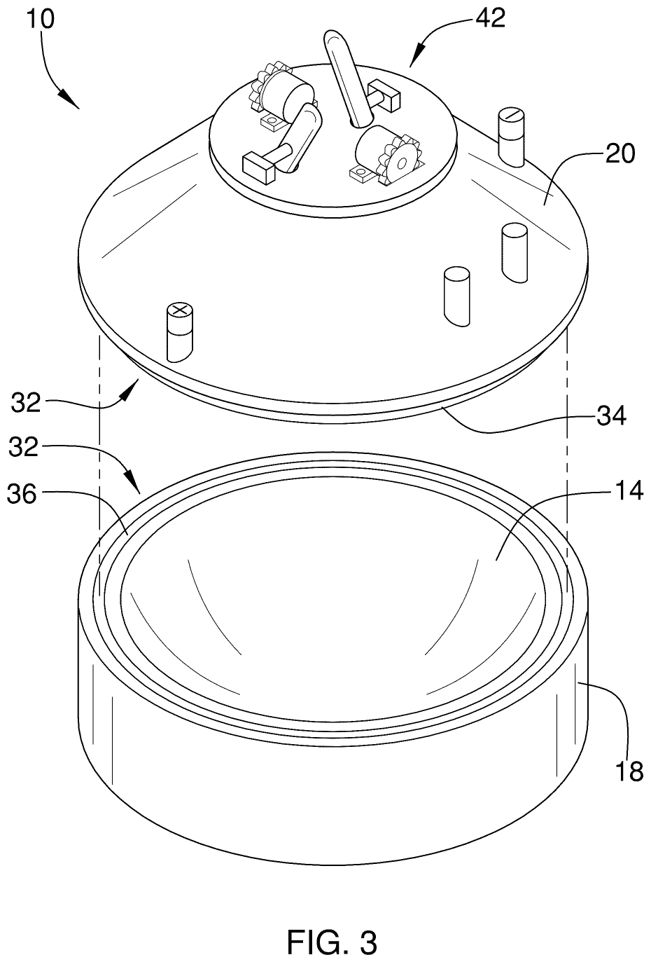

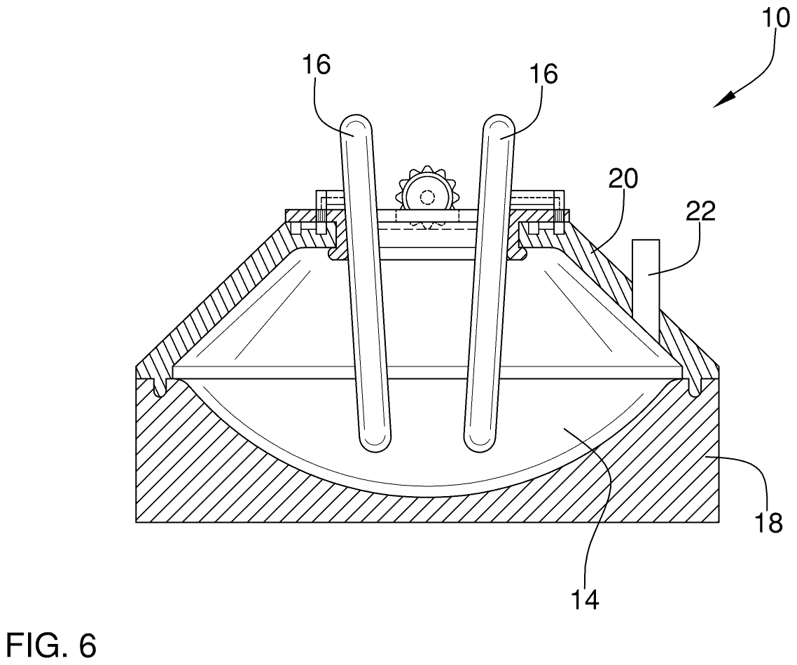

With reference now to the drawings, and in particular to FIGS. 1 through 10 thereof, a new lunar regolith reduction reactor system embodying the principles and concepts of an embodiment of the disclosure and generally designated by the reference numeral 10 will be described.

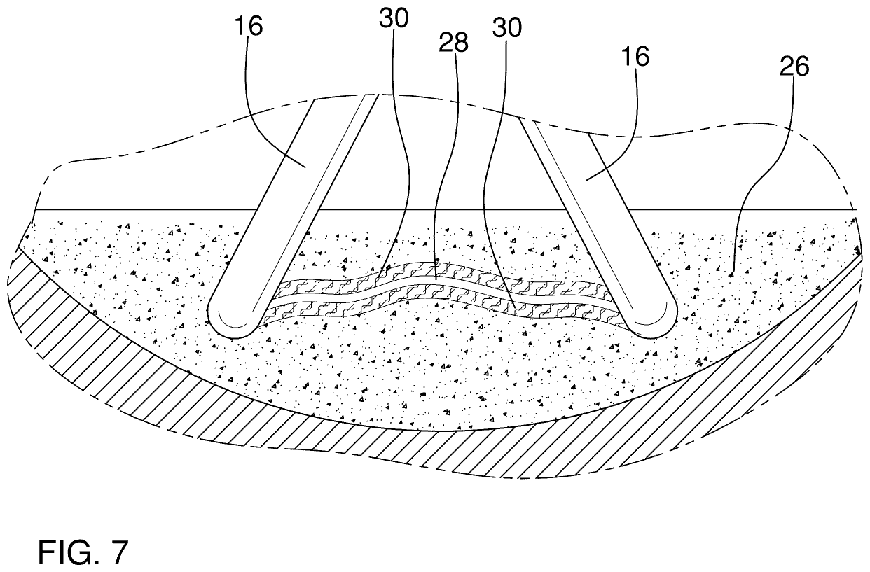

As best illustrated in FIGS. 1 through 10, the lunar regolith reduction reactor system 10 generally comprises a housing 12, a crucible 14, and a pair of electrodes 16. The housing 12 includes a base structure 18 and a cover structure 20 detachably connected to the base structure 18, a gas input port 22 to permit input of hydrogen gas into the housing 12, and a gas output port 24 to permit outgassing of water vapor and gases. The crucible 14 is designed to hold an amount of lunar regolith 26 in the housing 12. The electrodes 16 are disposed apart from one another and adjacent the crucible 14, wherein the electrodes 16 are connectable to a power source to generate an electric arc 28 to heat lunar regolith 26 in the crucible 14 and initiate a reduction reaction to separate oxygen gas and reduce separated material into a molten state. FIG. 7 shows an example of the electric arc 28 reacting in the lunar regolith 26 and creating molten material 30.

FIGS. 1 through 3 show an exemplary embodiment of the housing 12, though virtually any housing 12 design that creates a reactor space is within the scope of the disclosure. The base structure 18 is generally cylindrical and can be made of durable, heat-resistant materials, such as iron or steel or ceramic. The cover structure 20 is generally conical and can also be made of durable, heat-resistant materials, such as iron or steel or ceramic. The housing 12 includes a connecting arrangement 32 to removably connect together the base structure 18 and the cover structure 20, which could be in the form of a projection 34 on the cover structure 20 and a groove 36 in the base structure 18. In one possible embodiment, the cover structure 20 could be connected to the base structure 18 by a hinge, and the cover structure 20 and base structure 18 could include a latching or locking device to more securely connect the cover structure 20 and the base structure 18. The base structure 18 is in sealing engagement with the cover structure 20 to prevent or minimize the escape of any gases. In the exemplary embodiment, the projection 34 is made of a resilient, heat-resistant material, such as a rubber or elastomer, that will provide both a sealing and a retention function by friction and/or form fit, but also would allow for disconnection of the cover structure 20 from the base structure 18. The crucible 14 is a concave dish mounted on or integrally formed with the base structure 18. In one possible embodiment, the crucible 14 could include a curved lip for pouring of molten material 30.

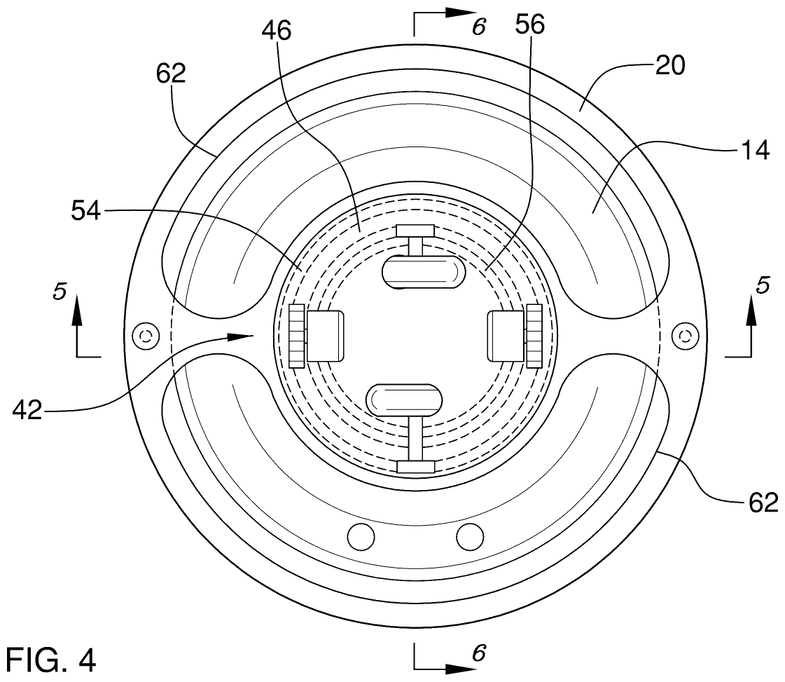

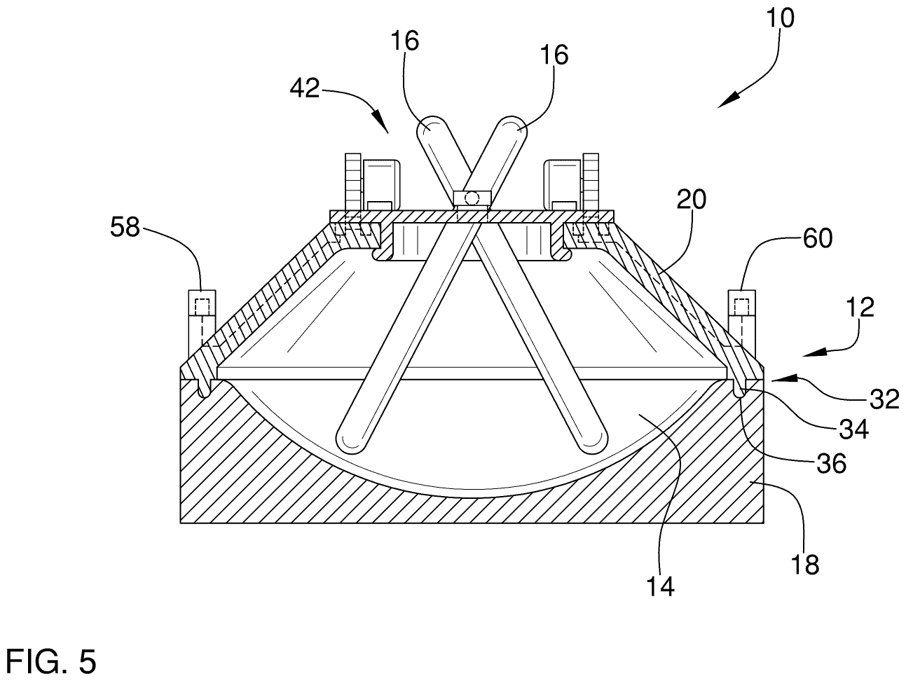

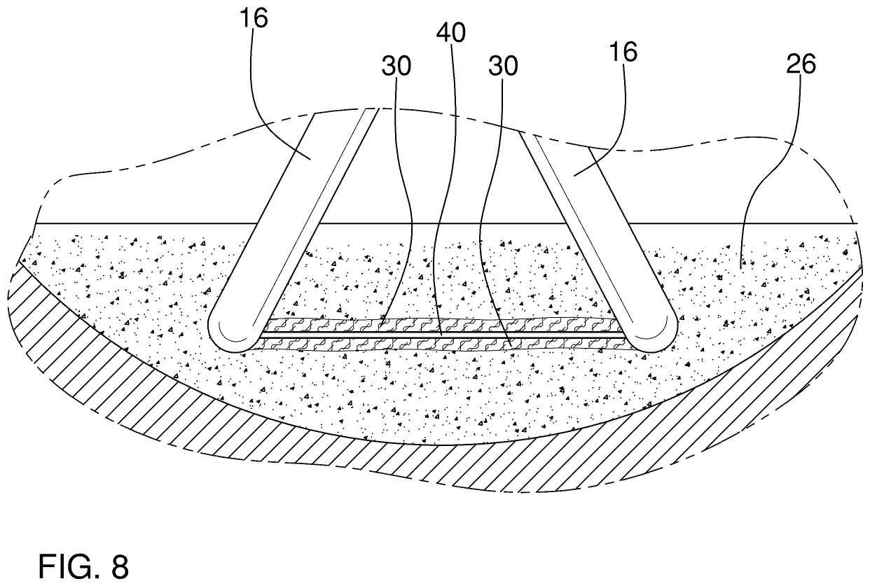

As shown in FIGS. 4 and 5, each of the electrodes 16 is an elongated rod. In one possible embodiment shown in FIG. 8, the electrodes 16 are connected by an electrical discharge machining (EDM) wire 40.

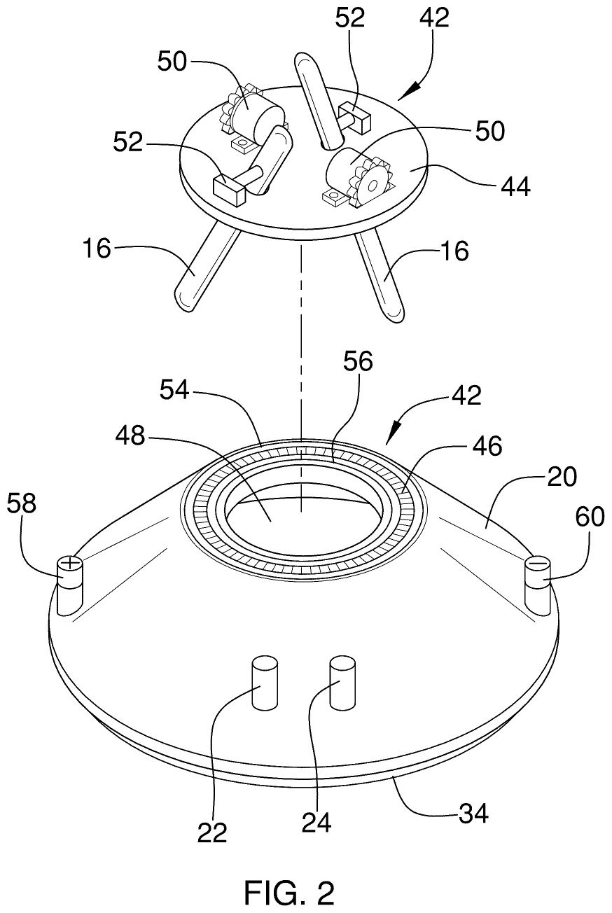

In the exemplary embodiment, the lunar regolith reduction reactor system 10 further includes a drive assembly 42. The drive assembly 42 rotatably supports the electrodes 16 to circulate the electrodes 16 through the lunar regolith 26 and thereby stir the lunar regolith 26 in the crucible 14. The rotation helps the electric arc 28 contact as much lunar regolith 26 as possible. The drive assembly 42 includes a support plate 44 rotatably mounted on the cover structure 20 and operatively connected to the electrodes 16. The drive assembly 42 also includes a ring gear 46 positioned about an orifice 48 in an upper portion of the cover structure 20 and ring gear motors 50 mounted on the support plate 44 and in engagement with the ring gear 46 to rotate the support plate 44. Other drive assemblies that rotate the electrodes 16 are within the scope of the disclosure. The drive assembly 42 includes a slip ring assembly to operatively connect the electrodes 16 to a power source. The slip ring assembly has a relatively standard design as shown in FIGS. 2 through 6, wherein the electrodes 16 are connected to slip ring brushes 52, which are in turn in contact with a positive slip ring 54 and a negative slip ring 56. The positive slip ring 54 and negative slip ring 56 are operatively connected to a positive post 58 and a negative post 60, which are in turn connected to a power source. Again, this is one exemplary embodiment and essentially any electrical connection to connect a power source to the electrodes 16 is within the scope of the disclosure and well known in the electrical arts.

FIG. 4 additionally shows an alternative design in which the cover structure 20 includes view windows 62. These could be included if it is desired to observe the reaction inside the housing 12, such as during testing or initial use in a lunar environment.

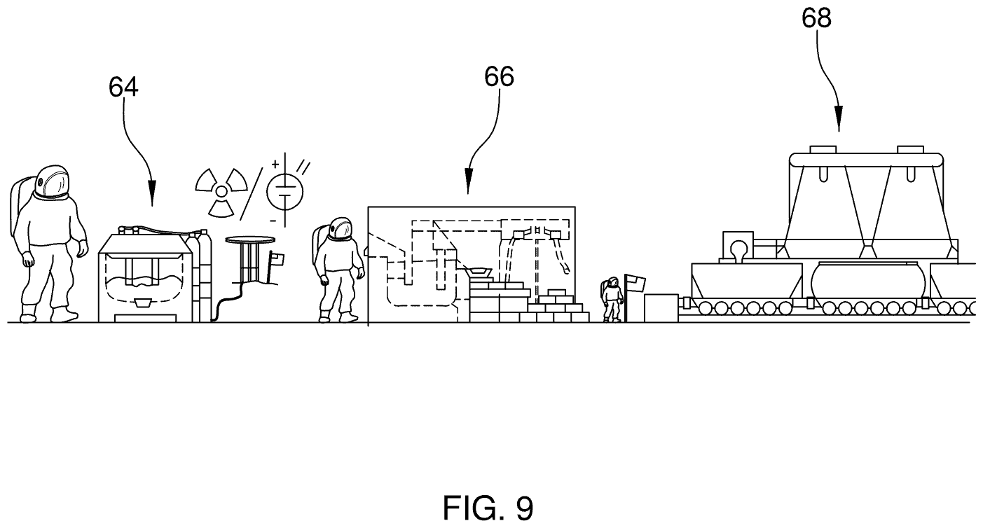

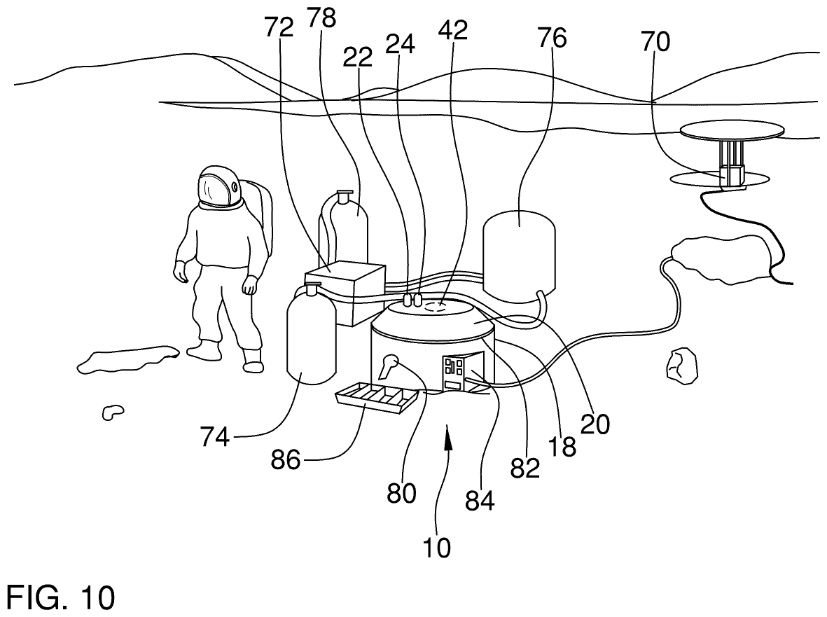

FIGS. 9 and 10 show examples of the lunar regolith reduction reactor system 10 as it could be used in a lunar environment. FIG. 9 shows how the lunar regolith reduction reactor system 10 could be scaled up from a small unit 64 for small batches, to a mid-sized unit 66 for medium batches, and finally to a large-scale unit 68 for large batches and processing. The small unit 64 could be about three to four cubic feet or possibly about one cubic meter, and thus rather compact and therefore relatively easily transportable, both on a spacecraft and on the lunar surface. It should be noted that some of the components of the lunar regolith reduction reactor system 10 shown, for example, in FIGS. 1 through 8, either are not shown in detail or are represented schematically for simplicity in FIGS. 9 and 10. However, components of the embodiments shown in FIGS. 1 through 8 are applicable or adaptable for use in the lunar environments depicted in FIGS. 9 and 10. FIG. 10 shows a modified design from that shown in FIGS. 1 through 6 that could be suitable for use in a lunar environment. In the embodiment shown in FIG. 10, the lunar regolith reduction reactor system 10 further comprises a power source 70, which could be solar or nuclear, or possibly an alternative source of energy. The cover structure 20 has a slightly different design than the exemplary embodiment shown in FIGS. 1 through 6, wherein the flat top portion is larger and the gas input port 22 and the gas output port 24 are located thereon. Rather than projecting out or being positioned on top of the cover structure 20, as shown in FIGS. 1 through 6, the drive assembly 42 is located inside the cover structure 20, as represented schematically by the dotted oval. The lunar regolith reduction reactor system 10 also comprises a pump assembly 72 and a hydrogen tank 74 connected to the gas input port 22, a condenser and electrolysis unit 76 connected to the gas output port 24, and an oxygen tank 78, each operatively connected by the pump assembly 72. As an alternative to pouring molten material 30 out of the crucible 14, a siphon 80 could be integrated into the base structure 18 of the lunar regolith reduction reactor system 10 for controlled removal or pouring of the molten material 30, as is well known in the metallurgical arts. For example, a movable refractory stop or similar device could be used to open and close the siphon 80, which could be operatively connected to the molten material 30 via a conduit in the base structure 18. A seal 82, such as a rubber gasket, is included on the cover structure 20, though it could be located on the base structure 18. A control unit 84 is also mounted on the base structure 18 for operation of the lunar regolith reduction reactor system 10. The control unit 84 could be of any common design and include manual controls as well as wireless communication for remote control.

The lunar regolith reduction reactor system 10 is used to process lunar regolith 26. First, the user places an amount of lunar regolith 26 in the crucible 14, which lunar regolith 26 has not been sorted or filtered. The user then closes the housing 12 by connecting the cover structure 20 to the base structure 18. The pair of electrodes 16 are then inserted into the lunar regolith 26. The pump assembly 72 is activated to pump hydrogen gas from the hydrogen tank 74 into the housing 12 via the gas input port 22. Power is provided to the electrodes 16, which generates an electric arc 28 and heats the lunar regolith 26 in the crucible 14 into a molten state, which causes a reduction reaction to separate oxygen gas and leave materials, such as iron, titanium, and silicon. The drive assembly 42 is activated to rotate the electrodes 16 and thereby circulate the electrodes 16 through the lunar regolith 26 and thereby stir the lunar regolith 26. The oxygen gas bubbles up into the hydrogen gas in the housing 12 and combines to form water vapor. In the embodiment shown in FIG. 10, the water vapor and any gases are removed from the housing 12 via the gas output port 24 and stored, such as by selectively conducting water vapor, hydrogen gas, oxygen gas, and trace gases from the housing 12 to the condenser and electrolysis unit 76, which in a known manner forms hydrogen gas and oxygen gas out of the water vapor. The hydrogen gas can be selectively conducted from the condenser and electrolysis unit 76 into the hydrogen tank 74 in a recycling process to recover the hydrogen gas for further use. In addition, the oxygen gas can be selectively conducted from the condenser and electrolysis unit 76 to the oxygen tank 78 for storage. The molten lunar regolith 26 is finally removed from the crucible 14, either by manual pouring of the molten material 30 or via the siphon 80. In the exemplary embodiment shown in FIG. 10, the molten material 30 can be siphoned out into a form 86 to create ingots or bars for further use in construction of buildings or machinery. This process could be tested on Earth by placing the lunar regolith reduction reactor system 10 in a vacuum environment to simulate the lunar environment and by using simulated lunar regolith. The view windows 26 could be used in such a testing situation to monitor the reaction process inside the housing 12.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A lunar regolith reduction reactor system comprising:
a housing comprising a base structure, a cover structure detachably connected to said base structure, a gas input port to permit input of hydrogen gas into said housing, and a gas output port to permit outgassing of water vapor and gases;
a crucible configured to hold an amount of lunar regolith in said housing; and
a pair of electrodes disposed apart from one another and adjacent said crucible, wherein said electrodes are connectable to a power source to generate an electric arc to heat lunar regolith in said crucible and initiate a reduction reaction to separate oxygen gas and reduce separated material into a molten state.

2. The lunar regolith reduction reactor system of claim 1, further comprising a drive assembly rotatably supporting said electrodes to circulate said electrodes through and thereby stir lunar regolith in said crucible.

3. The lunar regolith reduction reactor system of claim 2, wherein said base structure is in sealing engagement with said cover structure.

4. The lunar regolith reduction reactor system of claim 2, wherein said housing comprises a connecting arrangement to removably connect together said base structure and said cover structure.

5. The lunar regolith reduction reactor system of claim 2, wherein said crucible comprises a concave dish mounted on or integrally formed with said base structure.

6. The lunar regolith reduction reactor system of claim 2, wherein each of said electrodes comprises an elongated rod.

7. The lunar regolith reduction reactor system of claim 2, wherein said electrodes are connected by an electrical discharge machining wire.

8. The lunar regolith reduction reactor system of claim 2, further comprising a solar power source.

9. The lunar regolith reduction reactor system of claim 2, further comprising a nuclear power source.

10. The lunar regolith reduction reactor system of claim 2, wherein said drive assembly comprises a support plate rotatably mounted on said cover structure and operatively connected to said electrodes.

11. The lunar regolith reduction reactor system of claim 2, wherein said drive assembly comprises a ring gear disposed about an orifice in an upper portion of said cover structure and ring gear motors mounted on said support plate and in engagement with said ring gear to rotate said support plate.

12. The lunar regolith reduction reactor system of claim 2, wherein said drive assembly comprises a slip ring assembly operatively connecting said power source and said electrodes.

13. The lunar regolith reduction reactor system of claim 2, further comprising a pump assembly and a hydrogen tank connected to said gas input port, a condenser and electrolysis unit connected to said gas output port, and an oxygen tank, each operatively connected by said pump assembly.

14. A method of processing lunar regolith using a lunar regolith reduction reactor system comprising a housing comprising a base structure, a cover structure detachably connected to said base structure, a gas input port to permit input of hydrogen gas into said housing, and a gas output port to permit outgassing of water vapor and gases; a crucible configured to hold an amount of lunar regolith in said housing; and a pair of electrodes disposed apart from one another and adjacent said crucible, wherein said electrodes are connectable to a power source to generate an electric arc to heat lunar regolith in said crucible and initiate a reduction reaction to separate oxygen gas and reduce separated material into a molten state, said method comprising the steps of:
placing an amount of lunar regolith in said crucible that has not been sorted or filtered;
connecting said cover structure to said base structure;
inserting said pair of electrodes into the lunar regolith;
supplying hydrogen gas into said housing via said gas input port;
generating an electric arc and heating the lunar regolith in said crucible and initiating a reduction reaction to separate oxygen gas and thereby reduce separated material into a molten state;
removing and storing water vapor and gases from said housing via said gas output port; and
removing molten lunar regolith from said crucible.

15. The method of claim 14, wherein said lunar regolith reduction reactor system further comprises a drive assembly rotatably supporting said electrodes to circulate said electrodes through and thereby stir lunar regolith in said crucible, and said method further comprises rotating said electrodes and thereby circulating said electrodes through the lunar regolith and thereby stirring the lunar regolith.

16. The method of claim 15, wherein said lunar regolith reduction reactor system further comprises a pump assembly and a hydrogen tank connected to said gas input port, a condenser and electrolysis unit connected to said gas output port, and an oxygen tank, each operatively connected by said pump assembly, wherein said method further comprises selectively conducting water vapor, hydrogen gas, oxygen gas, and trace gases from said housing to said condenser and electrolysis unit and forming hydrogen gas and oxygen gas out of said water vapor.

17. The method of claim 16, wherein said method further comprises selectively conducting hydrogen gas into said housing and selectively conducting hydrogen gas from said condenser and electrolysis unit into said hydrogen tank.

18. The method of claim 17, wherein said method further comprises selectively conducting oxygen from said condenser and electrolysis unit to said oxygen tank.

19. A lunar regolith reduction reactor system comprising:
a housing comprising a base structure, a cover structure detachably connected to said base structure, a gas input port to permit input of hydrogen gas into said housing, and a gas output port to permit outgassing of water vapor and gases, wherein:
said base structure is in sealing engagement with said cover structure;
said housing comprises a connecting arrangement to removably connect together said base structure and said cover structure;
a crucible configured to hold an amount of lunar regolith in said housing, wherein said crucible comprises a concave dish mounted on or integrally formed with said base structure;
a pair of electrodes disposed apart from one another and adjacent said crucible, wherein said electrodes are connectable to a power source to generate an electric arc to heat lunar regolith in said crucible and initiate a reduction reaction to separate oxygen gas and reduce separated material into a molten state, wherein each of said electrodes comprises an elongated rod;
a drive assembly rotatably supporting said electrodes to circulate said electrodes through and thereby stir lunar regolith in said crucible, wherein:
said drive assembly comprises a support plate rotatably mounted on said cover structure and operatively connected to said electrodes;
said drive assembly comprises a ring gear disposed about an orifice in an upper portion of said cover structure and ring gear motors mounted on said support plate and in engagement with said ring gear to rotate said support plate;
said drive assembly comprises a slip ring assembly operatively connecting said power source and said electrodes;
a solar power source or a nuclear power source; and
a pump assembly and a hydrogen tank connected to said gas input port, a condenser and electrolysis unit connected to said gas output port, and an oxygen tank, each operatively connected by said pump assembly.

20. The lunar regolith reduction reactor system of claim 19, wherein said electrodes are connected by an electrical discharge machining wire.
